(19) United States
(12) Patent Application Publication
(10) Pub. No.: US 2007/0029910 A1
(43) Pub. Date: Feb. 8, 2007

(54) Plasma display panel and method of manufacturing the same

(76) Inventors: Hyun Kim, Suwon-si (KR); Kyoung-Doo Kang, Suwon-si (KR); Se-Jong Kim, Suwon-si (KR); Yun-Hee Kim, Suwon-si (KR); Hyun Soh, Suwon-si (KR); Jin-Won Han, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/498,819

(22) Filed: Aug. 4, 2006

(30) Foreign Application Priority Data
Aug. 6, 2005 (KR) 10-2005-0072007

(51) Int. Cl. H01J 21/10

(52) U.S. Cl. 313/306

(57) ABSTRACT

A plasma display panel has connection passage units that facilitate exhaust and injection processes during manufacture of the plasma display panel. The plasma display panel includes a first substrate, a second substrate facing the first substrate, the first and second substrates being spaced apart by a predetermined distance, barrier ribs for defining a plurality of discharge cells in a space between the first substrate and the second substrate, first and second electrodes extending parallel to each other on the first substrate, and a first dielectric layer covering the first and second electrodes, the first dielectric layer including a field concentration groove between the first and second electrodes within each discharge cell, and connection passage units for connecting field concentration grooves in adjacent discharge cells

### BACKGROUND OF THE INVENTION

1. Field of the Invention

The present invention relates to a plasma display panel (PDP). More particularly, the present invention relates to a PDP having connection passage units that facilitate exhaust and injection processes when manufacturing the PDP.

2. Description of the Related Art

Recently, the use of PDPs as large flat display devices has been emphasized. A PDP may include two substrates with a space filled with a discharge gas therebetween, and a plurality of electrodes formed on the substrates. The PDP displays desired images using visible light emitted through a process of exciting a luminescent material, e.g., a phosphor, in a predetermined pattern with ultraviolet (UV) light generated from a discharge of the discharge gas in the space when a voltage is applied to the electrodes.

PDPs may be classified into direct (DC) type PDPs and alternating current (AC) type PDPs according to discharge types. PDPs may also be classified into facing discharge type panels and surface discharge type panels according to electrode arrangement.

FIG. 1A illustrates a cross-sectional view of a discharge cell having a field concentration groove 20 of an AC surface discharge type PDP, and FIG. 1B illustrates a schematic plan view of the discharge cell of FIG. 1A as seen from a first substrate 2 of the PDP.

Referring to FIGS. 1A and 1B, the AC facing discharge type PDP may include a first panel and a second panel. The first panel may include the first substrate 2, X and Y electrodes (common and scanning electrodes) 12 and 14, each including a transparent electrode 12a and 14a and a bus electrode 12b and 14b, a first dielectric layer 9a, a protective layer 10, and the field concentration groove 20.

The second panel may include a second substrate 4, address electrodes 16, and a second dielectric layer 9b. Barrier ribs 6 that partition the discharge cell may be interposed between the first and second panels. A phosphor layer 8 may be coated on the barrier ribs 6 and the first substrate 2.

The field concentration groove 20 concentrates an electric field in a groove. Although this groove increases a space between the X and Y electrodes 12 and 14, a driving voltage applied to the electrodes is not increased. The discharge space can be increased by increasing the distance between the X electrodes 12 and the Y electrodes 14, thus increasing the light emission efficiency. Also, the transmittance of visible light emitted from the discharge cell through the first panel can be increased in proportion to a depth of the groove in the field concentration groove 20, i.e., how much of the first dielectric layer 9a is removed.

The barrier ribs 6 may be closed, and may not be connected to neighboring discharge cells, so that neighboring field concentration grooves formed in discharge cells neighboring the barrier ribs 6 may be separated from each other.

Such closed barrier ribs do not cause cross talk that occurs with open shaped barrier ribs. However, closed shaped barrier ribs are not efficient in exhausting impurities of a discharge space of discharge cells or injecting a discharge gas necessary for generating a discharge into discharge cells during the manufacture of PDPs.

### SUMMARY OF THE INVENTION

The present invention is therefore directed to a plasma display panel (PDP) and method of manufacturing the same, which substantially overcome one or more of the problems due to the limitations and disadvantages of the related art.

It is therefore a feature of an embodiment of the present invention to provide a PDP having connection passage grooves connecting the field concentration grooves.

It is another feature of an embodiment of the present invention to provide a method of manufacturing a PDP having connection passage units connecting the field concentration grooves.

It is yet another feature of an embodiment of the present invention to provide a method of manufacturing a PDP that uses connection passage units to exhaust impurities during manufacture of the PDP

It is still another feature of an embodiment of the present invention to provide a method of manufacturing a PDP that uses connection passage units to inject discharge gas during manufacture of the PDP.

At least one of the above and other features and advantages of the present invention may be realized by providing a plasma display panel, including a first substrate, a second substrate facing the first substrate, the first and second substrates being spaced apart by a predetermined distance, barrier ribs for defining a plurality of discharge cells in a space between the first substrate and the second substrate, first and second electrodes extending parallel to each other on the first substrate, and a first dielectric layer covering the first and second electrodes, the first dielectric layer including a field concentration groove between the first and second electrodes within each discharge cell, and connection passage units for connecting field concentration grooves in adjacent discharge cells.

The connection passage units may be parallel to the first and second electrodes. The connection passage units may have smaller widths than the field concentration grooves.

The plasma display panel may include address electrodes on the second substrate, the address electrodes extending perpendicular to the first and second electrodes, a second dielectric layer covering the address electrodes, a luminescent layer in the discharge cells, and a discharge gas filling the discharge cells.

The barrier ribs may be closed and have a cross-section parallel to the first substrate that is polygonal, circular or oval. The connection passage units may be grooves having a trapezoidal or a rectangular cross-section perpendicular to the first substrate and parallel to the address electrodes. The luminescent layer may be on the second substrate. The plasma display panel may include a protective layer on the first dielectric layer.

The connection passage units may extend parallel to the first and second electrodes. The connection passage units may have smaller widths than widths of the field concentration grooves. The connection passage units are grooves may have a trapezoidal or rectangular cross-section perpendicular to the first substrate and parallel to the address electrodes. The connection passage units have a same cross-sectional shape as the field concentration grooves.

At least one of the above and other features and advantages of the present invention may separately be realized by providing a method of manufacturing a plasma display panel, the method including providing a first substrate having first and second electrodes extending parallel to each other, providing a second substrate facing the first substrate, the first and second substrate being spaced apart by a predetermined distance, providing barrier ribs for defining a plurality of discharge cells in a space between the first and second substrates, and forming a first dielectric layer that covers the first and second electrodes, the first dielectric layer including a field concentration groove between the first and second electrodes within each discharge cell, and connection passage units for connecting field concentration grooves in adjacent discharge cells.

The method may include securing the first and second substrates together, and exhausting impurities through the connection passage units. After exhausting, the method may include injecting discharge gas through the connection passage units. The method may include securing the first and second substrates together, and injecting discharge gas through the connection passage units.

Forming the field concentration grooves and the connection passage units may include etching. The field concentration grooves may be wider than the connection passage units.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1A illustrates a cross-sectional view of a discharge cell having a field concentration groove of an AC surface discharge type plasma display panel;

FIG. 1B illustrates a schematic plan view of the discharge cell of FIG. 1A as seen from a first substrate of the AC surface discharge type plasma display panel;

FIG. 2 illustrates a schematic partial plan view of a plasma display panel having connection passage units connected to field concentration grooves formed in every discharge cells, as seen from a first substrate according to an embodiment of the present invention;

FIG. 3 illustrates a perspective view of a first panel of a plasma display panel having connection passage units according to an embodiment of the present invention;

FIG. 4 illustrates an exploded perspective view of a plasma display panel according an embodiment of the present invention; and

FIGS. 5A and 5B illustrate cross-sectional views of discharge cells having field concentration grooves of a plasma display panel according an embodiment of the present invention.

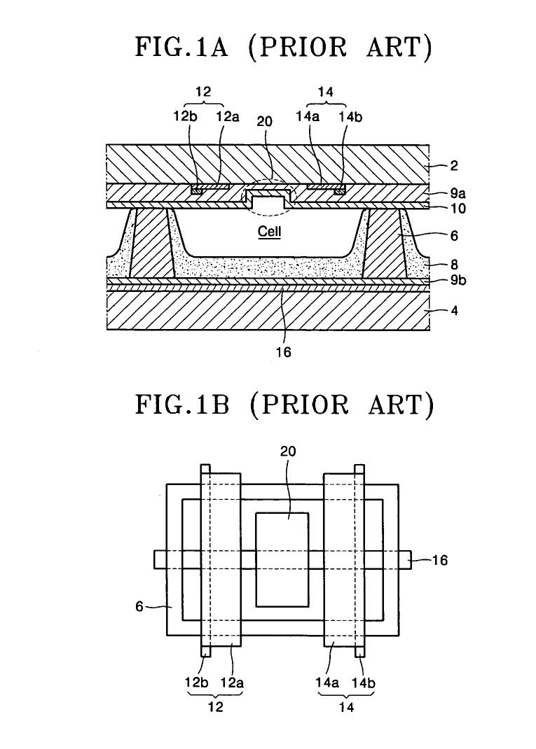

### DETAILED DESCRIPTION OF THE INVENTION

Korean Patent Application No. 10-2005-0072007, filed on Aug. 6, 2005, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

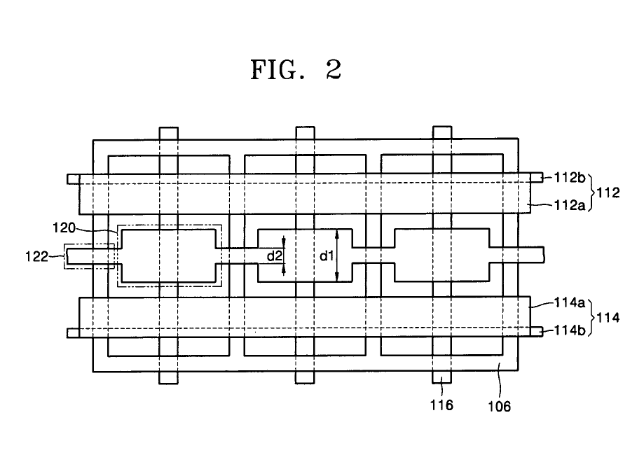

FIG. 2 illustrates a schematic partial plan view of a plasma display panel (PDP) having connection passage units 122 connected to field concentration grooves 120 formed in each discharge cell as seen from a first substrate according to an embodiment of the present invention.

Referring to FIG. 2, the field concentration grooves 120 of discharge cells may be formed in a first dielectric layer 109a corresponding to the center of X electrodes 112, 112a, and 112b, and Y electrodes 114, 114a, and 114b, and may be connected to each other through the connection passage units 122.

The connection passage units 122 may serve as passage spaces for connecting the field concentration grooves 120 of neighboring discharge cells, so that discharge spaces of neighboring discharge cells are connected to one another.

The connection passage units 122 may be used to exhaust impurities of discharge spaces of discharge cells in an exhaust process during the manufacture of the PDP. The connection passage units 122 may also be used to inject discharge gas for generating a discharge into discharge cells in an injection process during the manufacture of the PDP.

Discharge spaces of neighboring discharge cells of the PDP may be connected to one another, facilitating exhausting of impurities of discharge spaces and/or injecting the discharge gas into discharge cells during the process of manufacturing the PDP. Therefore, the PDP having the connection passage units 122 connected to the field concentration grooves 120 may solve problems that may arise during exhaust and/or injection processes used in the manufacture thereof.

The connection passage units 122 may be disposed parallel to the X and Y electrodes 112 and 114. That is, discharge spaces of neighboring discharge cells perpendicular to the X and Y electrodes 112 and 114 may not be connected. Alternatively or additionally, the connection passage units 122 may be disposed perpendicular to the X and Y electrodes 112 and 14 to connect adjacent discharge spaces via the field concentration grooves 120.

A width d2 of the connection passage units 122 may be smaller than a width d1 of the field concentration grooves 120. If the width d2 of the connection passage units 122 is too wide, cross talk may occur between neighboring discharge cells. Therefore, the width d2 of the connection passage units 122 may be selected so as to prevent the cross talk between the neighboring discharge cells, while facilitating exhaust and/or injection processes during manufacture of the PDP.

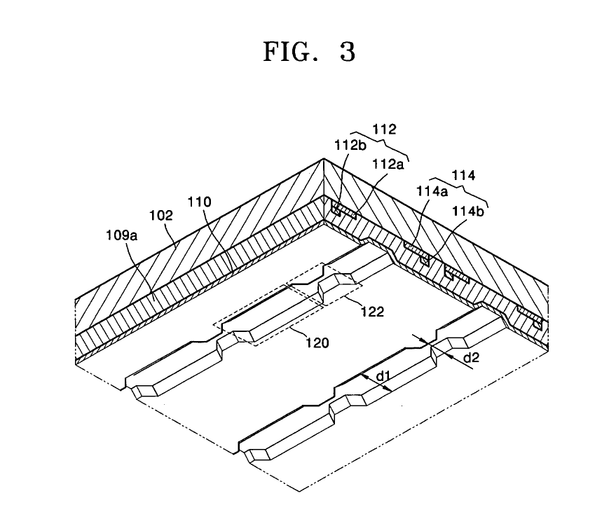

FIG. 3 illustrates a perspective view of a first panel of a PDP having connection passage units 122 according to an embodiment of the present invention. Referring to FIG. 3, the first panel may include a first substrate 102, a first dielectric layer 109a, a protective layer 110, X electrodes 112, 112a, and 112b, and Y electrodes 114, 114a, and 114b.

The field concentration grooves 120 and the connection passage units 122 may be notches or indentations that may be formed in the first dielectric layer 109a by patterning, e.g., etching, the first dielectric layer 109a. Alternatively, the patterning of the first dielectric layer may include adding material to a dielectric layer to create indentations in the dielectric layer 109a serving as the field concentration grooves 120 and the connection passage units 122. Further, the connection passage units 122 may be holes in the dielectric layer 109a, rather than the indentations shown in FIG. 3.

The field concentration grooves 120 may correspond to discharge cells in the first dielectric layer 109a. The field concentration grooves 120 may be connected to one another via the connection passage units 122.

The connection passage units 122 may facilitate exhaust and/or injection processes during manufacture of the PDP. The width d2 of the connection passage units 122 may be smaller than the width d1 of the field concentration units 120 so as to prevent cross talk between neighboring discharge cells.

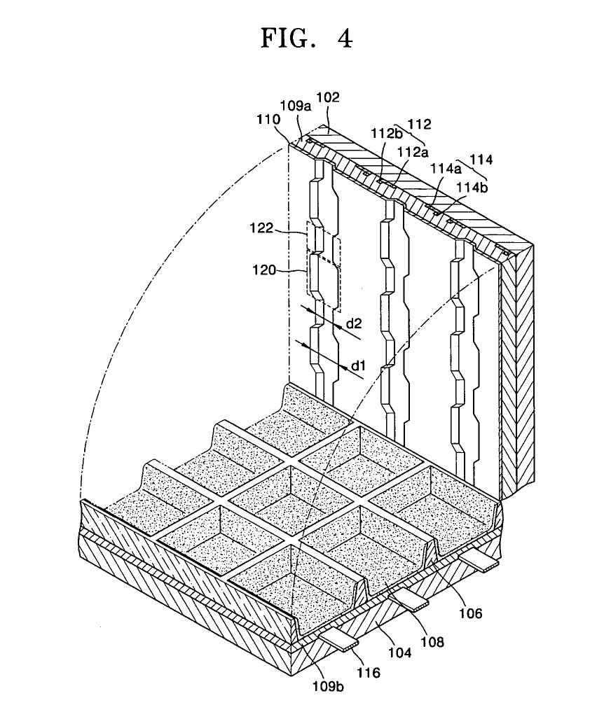

FIG. 4 illustrates an exploded perspective view of a PDP according an embodiment of the present invention. Referring to FIG. 4, a first panel may include the first substrate 102, the X electrodes 112, 112a, and 112b, the Y electrodes 114,114a, and 114b, the first dielectric layer 109a, and the protective layer 110. A second panel may include a second substrate 104, address electrodes 116, a second dielectric layer 109b, barrier ribs 106, and a luminescent material, e.g., a phosphor layer 108.

The barrier ribs 106 may form closed grid. Nine field concentration grooves 120 may be formed in spaces corresponding to nine discharge cells shown in FIG. 4, and may be connected via connection passage units 122.

Referring to FIGS. 3 and 4, the connection passage units 122 may be parallel to the X electrodes 112, 112a, and 112b, and the Y electrodes 114,114a, and 114b, may connect discharge spaces of neighboring discharge cells, and the width d2 thereof that may be smaller than the width d1 of the field concentration grooves 120 to prevent the cross talk between neighboring discharge cells as illustrated in FIG. 2.

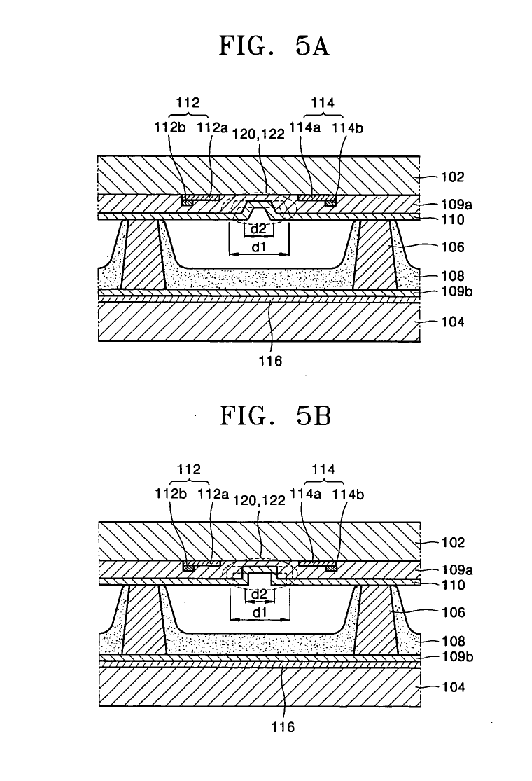

FIGS. 5A and 5B illustrate cross-sectional views of discharge cells including field concentration grooves of a PDP according an embodiment of the present invention.

Referring to FIGS. 5A and 5B, the PDP may include the first substrate 102, the second substrate 104, the barrier ribs 106, the phosphor layer 108, the first dielectric layer 109a, the second dielectric layer 109b, the protective layer 110, X electrodes 112, 112a, and 112b, Y electrodes 114,114a, and 114b, and the address electrodes 116. Patterning, e.g., etching, of the first dielectric layer 109a may be performed to create the field concentration grooves 120 and connection passage units 122 interposed between the X electrodes 112 and the Y electrodes 114.

A discharge gas at a pressure lower than atmospheric pressure, e.g., approximately 0.5 atm, may fill the discharge cells. Plasma discharge may be generated by the collision of particles of the discharge gas with charges due to an electric field formed by a driving voltage applied to the electrodes located in each discharge cell, and, as a result of the plasma discharge, vacuum ultraviolet light may be generated. The discharge gas may be a gas mixture containing one or more of Ne gas, He gas, and Ar gas mixed with Xe gas.

The barrier ribs 106 may define the discharge cells to be basic units of an image, and may prevent cross-talk between the discharge cells. According to an embodiment of the present invention, a horizontal cross-section of the discharge cells, i.e., a cross-section parallel to the first substrate 102 and the second substrate 104, may be, for example, polygonal, e.g., rectangular, hexagonal, or octagonal, circular, or oval, and may vary within the PDP. In the current embodiment of the present invention, the barrier ribs 106 of the PDP are primarily closed, as illustrated in FIG. 4.

Electrons in the phosphor layer 108 are excited by absorbing vacuum ultraviolet light generated by discharge, resulting in photo luminescence. That is, visible light is generated when the excited electrons of the phosphor layer 108 return to a stable state. The phosphor layer 108 may include, e.g., red, green, and blue phosphor layers such that the plasma display panel can display a full color image. The red, green, and blue phosphor layers may constitute a unit pixel in the discharge cell. The red phosphor may be (Y,Gd)BO₃:Eu³⁺, etc., the green phosphor may be Zn₂SiO₄:Mn²⁺, etc., and the blue phosphor may be BaMgAl₁₀O₁₇:Eu²⁺, etc., but the present invention is not limited thereto.

The phosphor layer 108 may be formed in the second substrate 104 in the discharge cells. However, locations of the phosphor layer according to embodiments of the present invention are not limited thereto, and various arrangements can be used.

The first dielectric layer 109a may be used as an insulating film for insulating the X electrodes 112 and the Y electrodes 114, and may be formed of a material having high electrical resistance and high light transmittance. Some charges generated by the discharge may form wall charges on the protective layer 110 near the first dielectric layer 109a due to an electrical attractive force caused by the polarity of a voltage applied to each of the X and Y electrodes 112 and 114.

The second dielectric layer 109b may be used as an insulating film for insulating the address electrodes 116, and may be formed of a material having high electrical resistance. Since the second dielectric layer 109b does not transmit visible light, a material having high light transmittance is not required.

The protective layer 110 may protect the first dielectric layer 109a, and may facilitate discharge by increasing the emission of secondary electrons. The protective layer 110 may be formed, e.g., magnesium oxide (MgO), etc.

The X electrodes 112 and the Y electrodes 114 may respectively include the transparent electrodes 112a and 114a and the bus electrodes 112b and 114b. However, since the address electrodes 116 do not transmit visible light, they may not include a transparent electrode and a bus electrode, but may have a single body structure.

The transparent electrodes 112a and 114a may be formed of a transparent material, e.g., indium tin oxide (ITO), which transmits visible light emitted from the discharge cells. The transparent electrodes 112a and 114a may have a relatively high electrical resistance, in which case the electrical conductivity of the transparent electrodes 112a and 114a may be increased by the inclusion of the bus electrodes 112b and 114b formed of a material having high electrical conductivity, e.g., a metal.

The field concentration groove 120 may be a groove, and may be formed by patterning, e.g., by etching, the first dielectric layer 109a. A discharge path between the X electrodes 112 and the Y electrodes 114 may be reduced by the field concentration groove 120. In addition, the field concentration effects of the central portion of the groove of the field concentration groove 120 may increase the density of electrons (negative charges) and ions (positive charges) in the field concentration groove 120, thereby facilitating discharge between the X electrodes 112 and the Y electrodes 114. Consequently, the distance between the X electrodes 112 and the Y electrodes 114 may be increased so as to increase the discharge space. Thus, the light emitting efficiency may be improved. Also, the transmittance of visible light emitted from the discharge cell through the first panel may be increased in proportion to the amount of the first dielectric layer 109a that is removed, i.e., etched away.

The connection passage units 122 with the smaller width d2 than the width d1 of the field concentration grooves 120 connect the field concentration grooves with the neighboring field concentration grooves so that discharge spaces of neighboring discharge cells can be connected, thereby facilitating the exhaust and injection processes during the manufacturing process of the plasma display panel.

In FIG. 5A, the cross-section of the connection passage unit 122, i.e., a cross-section perpendicular to the first substrate 102 and parallel to the address electrodes 116, is trapezoidal. In FIG. 5B, the cross-section of the connection passage unit 122 is rectangular. However, any suitable cross-section may be used.

Further, while the cross-section of the field concentration grooves 120, i.e., a cross-section perpendicular to the first substrate 102 and parallel to the address electrodes 116, is shown FIGS. 5A and 5B as having the same cross-sectional shape, although wider than, that of the connection passage unit 122, they are not limited thereto, and the cross-section of the field concentration grooves 120 can have shapes different from that of the connection passage unit 122.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a first substrate;
a second substrate facing the first substrate, the first and second substrates being spaced apart by a predetermined distance;
barrier ribs for defining a plurality of discharge cells in a space between the first substrate and the second substrate;
first and second electrodes extending parallel to each other on the first substrate; and
a first dielectric layer covering the first and second electrodes, the first dielectric layer including
a field concentration groove between the first and second electrodes within each discharge cell, and
connection passage units for connecting field concentration grooves in adjacent discharge cells.

2. The plasma display panel as claimed in claim 1, wherein the connection passage units are parallel to the first and second electrodes.

3. The plasma display panel as claimed in claim 1, wherein the connection passage units have smaller widths than the field concentration grooves.

4. The plasma display panel as claimed in claim 1, further comprising:
address electrodes on the second substrate, the address electrodes extending perpendicular to the first and second electrodes;
a second dielectric layer covering the address electrodes;
a luminescent layer in the discharge cells; and
a discharge gas filling the discharge cells.

5. The plasma display panel as claimed in claim 4, wherein the barrier ribs are closed and have a cross-section parallel to the first substrate that is polygonal, circular or oval.

6. The plasma display panel as claimed in claim 4, wherein the connection passage units are grooves having a trapezoidal cross-section perpendicular to the first substrate and parallel to the address electrodes.

7. The plasma display panel as claimed in claim 4, wherein the connection passage units are grooves having a rectangular cross-section perpendicular to the first substrate and parallel to the address electrodes.

8. The plasma display panel as claimed in claim 4, wherein the luminescent layer is on the second substrate.

9. The plasma display panel as claimed in claim 4, further comprising a protective layer on the first dielectric layer.

10. The plasma display panel as claimed in claim 4, wherein the connection passage units extend parallel to the first and second electrodes.

11. The plasma display panel as claimed in claim 10, wherein the connection passage units have smaller widths than widths of the field concentration grooves.

12. The plasma display panel as claimed in claim 11, wherein the connection passage units are grooves having a trapezoidal cross-section perpendicular to the first substrate and parallel to the address electrodes.

13. The plasma display panel as claimed in claim 11, wherein the connection passage units are grooves having a rectangular cross-section perpendicular to the first substrate and parallel to the address electrodes.

14. The plasma display panel as claimed in claim 11, wherein the connection passage units have a same cross-sectional shape as the field concentration grooves.
